(19) United States
(12) Patent Application Publication
(10) Pub. No.: US 2026/0235226 A1
(43) Pub. Date: Aug. 13, 2026

(54) FLOAT-CONTROLLED GATE FOR STEADY WATER FLOW

(71) Applicants: Alexander William Ewers, canon city, CO (US); Steadman James Brunson, canon city, CO (US); Dimitri Jackson Zamarripa, canon city, CO (US); Thomas Robert Fergusone, Canon CIty, AK (US)

(72) Inventors: Alexander William Ewers, canon city, CO (US); Steadman James Brunson, canon city, CO (US); Dimitri Jackson Zamarripa, canon city, CO (US); Thomas Robert Fergusone, Canon CIty, AK (US)

(21) Appl. No.: 19/458,776

(22) Filed: Jan. 24, 2026

Related U.S. Application Data
(60) Provisional application No. 63/756,859, filed on Feb. 11, 2025.

(51) Int. Cl. F16K 31/30; E02B 13/02; F16K 3/02; F16K 31/52

(52) U.S. Cl. CPC F16K 31/30; E02B 13/02; F16K 3/0254; F16K 31/523

(57) ABSTRACT

A flow control gate assembly has a horizontally adjustable gate in a frame defining a horizontally adjustable opening; and a vertically adjustable gate defining a vertically adjustable opening coupled by a flexible joint to a first end of a control lever, a second end of the control lever coupled to a float, the vertically adjustable gate. The horizontally adjustable opening close to, and in series with, the vertically adjustable opening. The control lever being disposed in a slot of a frame and configured such that if the float is lowered to the frame the control lever raises the vertically adjustable gate, and if the float is raised by high water the control lever lowers the vertically adjustable gate.

### CLAIM TO PRIORITY

This document claims priority to U.S. Provisional Patent Application 63/756,859 filed 11 Feb. 2025.

### GOVERNMENT RIGHTS CLAUSE

This invention was made with government support under grant number 2024-39410-43223 awarded by the United States Department of Agriculture (USDA). The government has certain rights in the invention.

### BACKGROUND

Detention basins are required in most municipalities when a previously undisturbed area is developed potentially resulting in a higher peak runoff discharge into downstream facilities and streams. The most common reason for higher peak runoff is because of an increase in impervious area, such as pavement and structures, which decreases the area where water is able to percolate into the ground. These detention basins typically must be drained at a flow rate high enough to remove enough water to avoid overflow during continuing or succeeding episodes of runoff yet low enough that outflow does not exceed capacity of downstream facilities, rivers, and streams.

Irrigation systems are used for farming throughout the western United States and in many other countries wherever natural rainfall is insufficient for growing adequate crops. Many such irrigation systems involve water flowing in irrigation ditches, these irrigation ditches often have branches; typical systems were formed as partnerships of multiple farms that cooperated to build systems of irrigation ditches and each farm desires their share of water from the irrigation system be delivered through a branch ditch with a delivery gate. Typically, each farm is periodically given a water flow of an amount determined by a manager according to a number of shares owned by the farm for a period of time also determined by the manager. Aqueducts delivering water to municipalities may include ditches similar to those of irrigation systems rather than being in pipes throughout; in some smaller communities the source of municipal water may even be a branch ditch of an irrigation system.

Current methods of restricting the post-development peak discharge to equal predevelopment discharge levels or other limits of downstream facilities include using a stationary culvert, weir, manually adjustable gate, or a combination of thereof. These devices only allow the discharge to occur when the water level in the detention basin is at its peak height which usually occurs for a relatively short amount of time.

Water height and flow in irrigation ditches may vary from time to time, for example as branch ditches are enabled or disabled, and it is often desirable to regulate water flow into particular branches or to specific farms. Similarly, aqueduct systems for bringing water to city water systems also often have branches so that more than one water system or water treatment plant can be fed by the aqueduct. It is also desirable to regulate water flow from a diversion structure or reservoir in a stream through a headgate into an irrigation ditch or aqueduct to ensure that the ditch or aqueduct gets adequate flow without overflowing despite changes in stream flow or reservoir levels and complying with flow limits imposed by water court decrees.

Electronically-controlled gates are known for controlling water flow. These require a source of electrical power and may require communications, both of which are often lacking in the rural areas hosting many irrigation systems and farms.

A prior, vertical-only, float-controlled gate is described in U.S. Pat. No. 9,638,334. The float-controlled gate of U.S. Pat. No. 9,638,334 is described as for use in controlling output flow from detention basins.

### SUMMARY

The present embodiments include a flow control system having float-controlled, vertical, flow control gate combined with a horizontal, adjustable, gate to permit a wide range of flow adjustment. In embodiments, a float control lever is coupled at a first end to the vertical gate portion with a flexible joint permitting the float control arm to be positioned at a wide range of angles to the vertical gate. Embodiments incorporate a float or buoy, a lever, a curved track, and a vertical steel gate plate adjacent an opening adjustable by a horizontal, controllable, gate. The buoy is connected to a second end of the lever. The lever rests on the curved track so that when the buoy is raised by rising water surface elevation, the vertical gate is lowered and inversely when the buoy is lowered by the receding water surface elevation, the vertical gate is raised. The gate is placed in front of the opening of the horizontal gate so that if the vertical gate is completely lowered, the overall opening is smaller than when the vertical gate is raised. The buoy or float floats at the water surface so that a vertical distance between the center of the buoy and the centroid of the orifice opening is equal to the head of water ahead of the flow control system.

In an embodiment, a flow control gate assembly has a horizontally adjustable gate in a frame defining a horizontally adjustable opening; and a vertically adjustable gate defining a vertically adjustable opening coupled by a flexible joint to a first end of a control lever, a second end of the control lever coupled to a float, the vertically adjustable gate. The horizontally adjustable opening close to, and in series with, the vertically adjustable opening. The control lever being disposed in a slot of a frame and configured such that if the float is lowered to the frame the control lever raises the vertically adjustable gate, and if the float is raised by high water the control lever lowers the vertically adjustable gate.

### BRIEF DESCRIPTION OF THE DRAWINGS

The embodiments can be best understood by those having ordinary skill in the art by reference to the following detailed description when considered in conjunction with the accompanying drawings in which:

FIG. 1A illustrates an improved float-controlled gate having a manually-operated horizontal gate that sets target flow and a float-controlled, vertical, gate that adjusts opening area to counteract changing water levels.

FIG. 1B illustrates the float-controlled gate at low water level.

FIG. 1C illustrates the float-controlled gate at high water level, with float elevated and gate closed.

FIG. 1D illustrates a short-lever embodiment of the float-controlled gate.

FIG. 1E illustrates a long-lever embodiment of the float-controlled gate such as may be suitable for higher maximum flows and/or greater head variability than the short-lever embodiment of FIG. 1D.

FIG. 2A is a close-up view of the horizontal and vertical gates of FIGS. 1A-1C.

FIG. 2B is a view of the horizontal gate of the float-controlled gate assembly.

FIG. 2C is a perspective view of a side of the frame of the float-controlled gate assembly.

FIG. 2D is a side view of the frame of the float-controlled gate assembly, showing close spacing between horizontal and vertical gates.

FIG. 2E is an exploded diagram of a frame portion associated with the horizontal gate.

FIG. 3 illustrates a simple pivot coupling between the float control lever of FIG. 1A-1C and the vertical gate of FIG. 1A-1C.

FIG. 4 is a sketch of an improved coupling between the float control lever and the vertical gate that allows for the vertical gate to be positioned at an angle to the float control lever.

FIG. 5 is a lateral view of the improved coupling of FIG. 4.

FIG. 6A illustrates the float control lever with a coupling slider that helps retain the float control lever in the channel of the curved frame.

FIG. 6B illustrates an isolated coupling slider of FIG. 6A.

FIG. 7 is a close-up view of the horizontal gate in an embodiment showing the pinion turned by the handwheel, and the rack attached to the gate.

FIG. 8A illustrates curved frames constructed according to tables 1-8 for a short-lever embodiment.

FIG. 8B illustrates a curved frame constructed according to tables 1-8 for a long-lever embodiment.

FIG. 8C illustrates a bracket for coupling the curved frames of FIG. 8A or 8B to the stationary plate to ensure correct placement of the curved frame during construction of a system.

FIG. 9 illustrates an application of the disclosed devices to control of water flow in an irrigation system.

FIG. 10 is a flowchart illustrating operation of the gate system.

FIG. 11 and FIG. 12 are schematic drawings of an alternative horizontal gate for use with the vertical gate of the present invention, the embodiment of FIGS. 10 and 11 being actuated by a screw oriented vertically.

FIG. 13 are schematic drawings of another alternative horizontal gate embodiment actuated by a right-and-left threaded rod driven by a bevel gear.

### DETAILED DESCRIPTION OF THE EMBODIMENTS

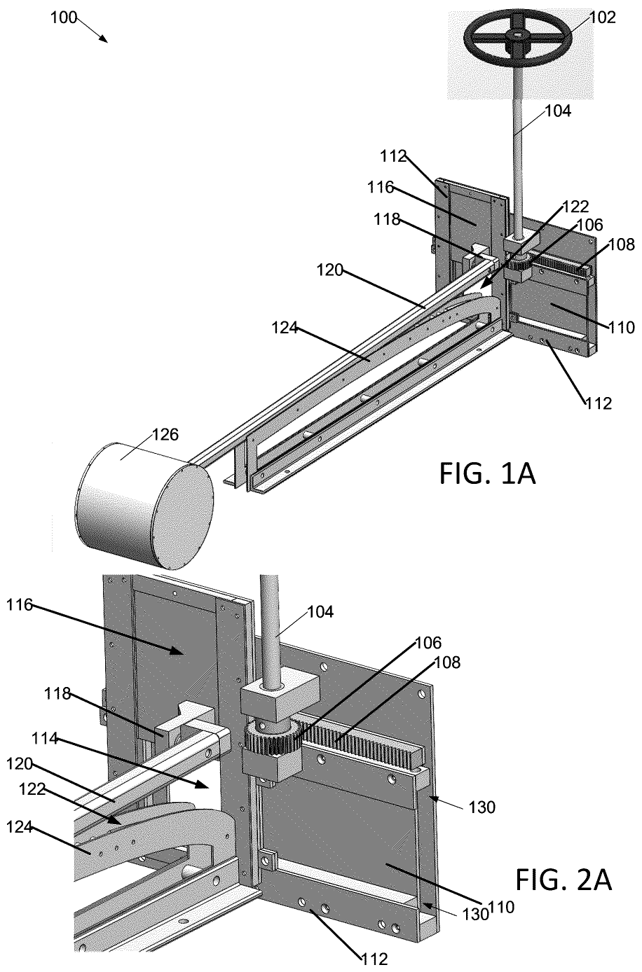

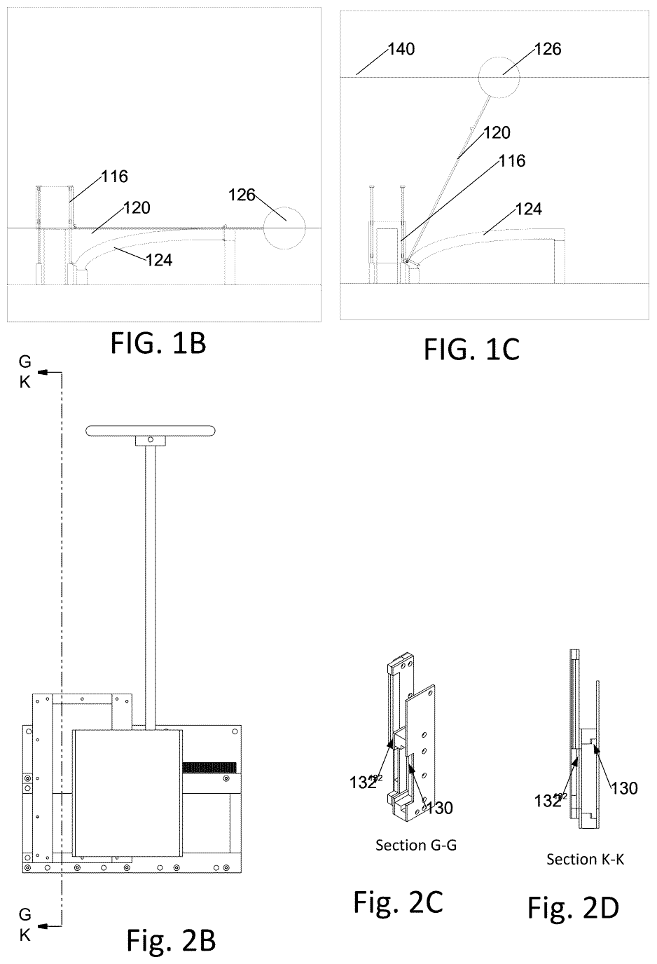

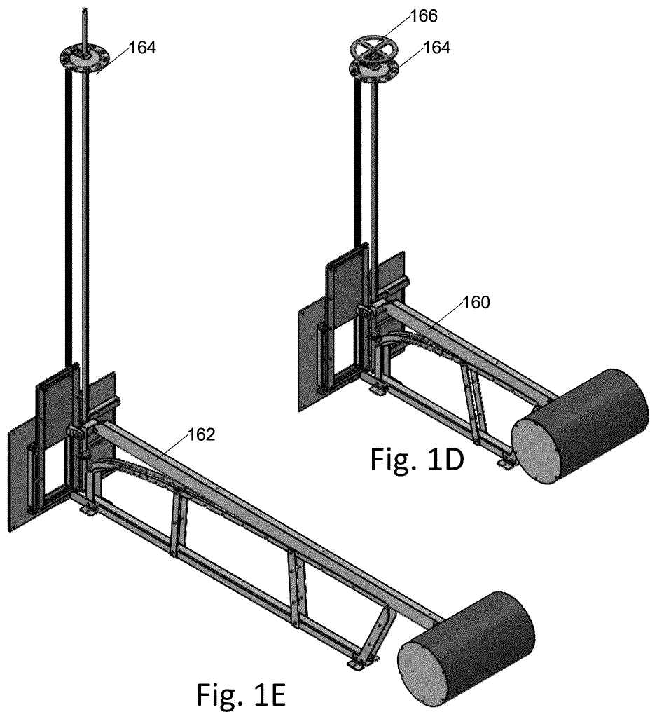

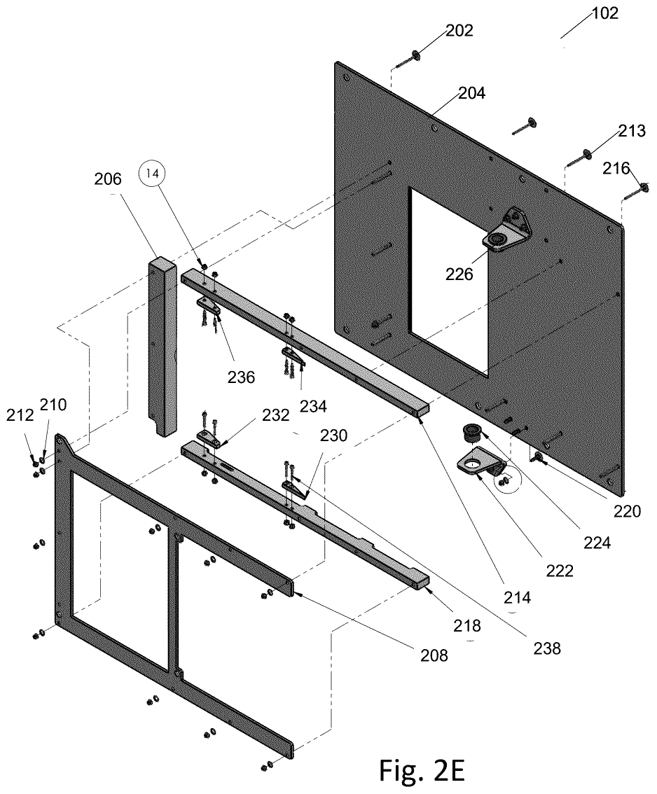

The adjustable gate assembly (100) of FIG. 1A and FIG. 2A has a manual adjustment wheel 102 coupled through a horizontal gate control shaft 104 or gear rod to a pinon 106 that engages in a rack 108. Rack 108 is attached to a horizontal gate 110 that is configured to slide horizontally in a slot in frame 112. Rotation of adjustment wheel 102 therefore slides horizontal gate 110 to open or close an opening 114. In an alternative embodiment, manual adjustment wheel 102 may be replaced, or supplemented with, with an electric motor drive that may be remotely controlled.

Gate assembly 100 also has a vertical gate 116 also configured to slide vertically in a slot in frame 112. Vertical gate 116 is coupled through a flexible joint 118 to a first end of float control lever 120. Lever 120 lies in a slot 122 of a curved frame 124. In embodiments, the slot in the curved frame is curved more sharply close to vertical gate 116 than far from vertical gate 116. At a second end of lever 120, lever 120 is attached to a buoy or float 126 that can operate vertical gate 116 through lever 120. Vertical gate 116 is also configured to open or close opening 114 to control water flow through opening 114.

The float-controlled gate operates as shown in FIG. 1B and FIG. 1C. At low water level, with float 126 and its float control lever 120 on or near curved frame 124, float control lever 120 holds vertical gate 116 up making opening 114 fully open. At high water level, with float 126 elevated towards a water surface 140, float control lever 120 allows the vertical gate 116 to partially close, thereby reducing opening 114 and thus adjust water flow.

An alternative embodiment illustrated in FIG. 1D has a shorter float control lever 160 than the float control lever 120 of FIG. 1A-1C or float control lever 162 of FIG. 1E. We note that the gate assembly cannot adjust water flows if water upstream of the gate is greater than a depth dependent on length of the float control lever. The embodiments of FIG. 1D-1E also include a dial 164 that may allow a ditchrider or other operator to quickly set the horizontal gate to a desired position, such as a position that previously provided a desired water flow. In some but not all embodiments, adjustment wheel 102, 166 is easily removable and keyed for rapid reinstallation, or lockable, to make difficult maladjustment by unauthorized persons.

Frame 112 is best viewed in FIGS. 2A, 2B, 2C, and 2D. FIG. 2B illustrates the frame 112 of the gate assembly as seen from the horizontal gate side. In some embodiments, spacing between the horizontal gate and the vertical gate is close, FIGS. 2C and 2D illustrating close spacing between the slot 130 in the frame for the horizontal gate and the slot 132 in the frame for the vertical gate. For purposes of this document, close spacing of the vertical and horizontal gates means that the horizontal and vertical gates when closed are separated by a distance less than half of a maximum height of the opening defined by the vertical gate when the vertical gate is fully open.

FIG. 2E is an exploded diagram of a frame portion of frame 112 that is associated with the horizontal gate 110. Bolts 202 pass through a stationary plate 204, thence through holes in a vertical spacer 206 and a horizontal-gate-frame front plate 208, then are secured with appropriate washers 210 and nuts 212. In some embodiments, bolts 202 are elevator bolts to allow close spacing between the horizontal and vertical gates. Similarly, more bolts 213 pass through stationary plate 204, a top spacer 214, and horizontal-gate front plate 208 and are similarly secured. Still more bolts 216 pass through stationary plate 204, a bottom spacer 218, and horizontal-gate front plate 208 and are similarly secured. Shorter bolts 220 pass through stationary plate 204 and a lower gear rod bracket 222 and are similarly secured. In a particular embodiment, lower gear rod bracket 222 is formed of bent aluminum stock. Lower gear rod bracket 222 holds a flanged bronze bearing 224. Similarly, an upper gear rod bracket 226 and flanged bearing is bolted to the stationary plate 204. When the gate assembly is assembled, control rod 104 is rotatably held in place by the flanged bronze bearings of the upper gear rod bracket 226 and lower gear rod bracket 222. Seal wedges 230, 232, lower horizontal spacer and seal wedges 234, 236 are bolted by adjustable bolts 238 to the upper horizontal spacer to permit setting a tension on the horizontal gate when the horizontal gate 110 (not shown in FIG. 2 is assembled into the frame.

In a particular embodiment, bottom spacer 218 has multiple slots for drainage, this has been found to help reduce fouling during operation.

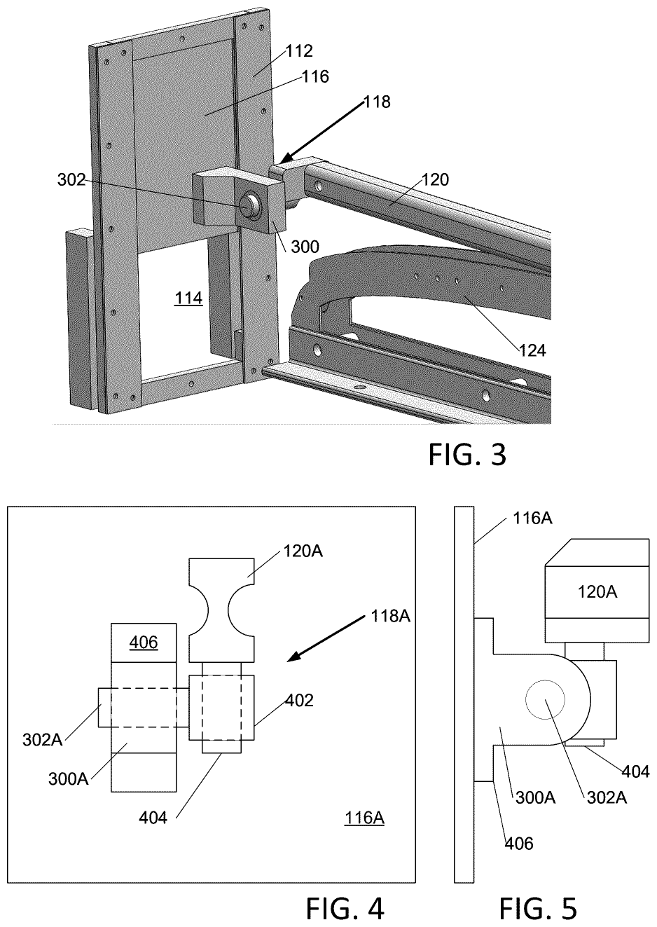

In some embodiments, as illustrated in FIG. 3, flexible joint 118 that couples vertical gate 116 to float control lever 120 incorporates a bracket 300 that is welded, bolted, or otherwise attached to vertical gate 116. A vertical pivot pin 302 passes horizontally through a hole in bracket 300 and is attached to float control lever 120 to allow float control lever to pivot vertically relative to bracket 300 and vertical gate 116.

In alternative embodiments, as illustrated in FIG. 4 and FIG. 5, an alternative flexible joint 118A is used to couple vertical gate 116A to the float control lever 120A bracket. As with the embodiment of FIG. 3, a bracket 300A is welded, bolted through flanges 406, or otherwise attached to vertical gate 116, and a vertical pivot pin 302A passes through a hole in bracket 300A. Vertical pivot pin 302A is attached to, or machined as a component part with, fitting 402. Fitting 402 is coupled to float control lever 120 by a horizontal pivot pin 404 passing through a hole in fitting 402. This alternative embodiment attaches float control lever 120 to vertical gate 116A while allowing free vertical movement of float 126 (FIG. 1) and allowing curved frame 124 to be positioned at angles other than perpendicular to vertical gate 116.

In operation, the float or buoy 126 is heavy enough, and lever 120 long enough, that, with the float and lever 120 resting on the curved frame 124 due to lack of water under the float, the lever 120 can raise vertical gate 116. Similarly, when water raises the float, the vertical gate 116 is heavy enough to close as far as permitted by lever 120. The curved frame 124 is shaped such that water flow through the vertical gate at high water levels and high float elevation is approximately the same as water flow through the vertical gate at low water levels and low float elevations.

A simplified orifice equation is as follows:

$$Q = {C}_{d} A \sqrt{2 gH}$$

Where:
Q=Flow [CFS]
C_{d}=Coefficient of Discharge [0.68]
A=Area [sq. ft.]
g=Gravity [32.2 ft/sec\hat{ }2]
H=Centerline Head [ft]

We experimentally verified that our coefficient of discharge C_{d} is in a range from 0.6 to 0.7.

In an embodiment, an orifice equation that accounts for low head, solved for gate opening height, is used. This orifice equation is as follows:

$${E}_{door} = {[ {( - \frac{Q}{\frac{2}{3} {C}_{d} W \sqrt{2 g}} + {W}_{sel}^{\frac{3}{2}} )}^{2} ]}^{\frac{1}{3}} + {W}_{SEL}$$

$$and$$

$$H = {W}_{SEL} - \frac{{E}_{door}}{2}$$

Where:
E_{door}=Gate opening height [ft]
H=Head [ft]
Q=Flow [CFS]
C_{d}=Coefficient of discharge [0.68]
W=Gate opening width [ft]
g=Gravity [32.2 ft/sec\hat{ }2]
W_{SEL}=Water surface elevation [ft]

We have used this equation to model the curve so the gate is at the correct opening height for a given water surface elevation. We therefore construct the curve to produce door heights approximately according to the following tables:
For: Q=1 CFS, W=5 in, C_{d}=0.68, and g=32.2 ft/sec\hat{ }2, with a 5.75-foot float rod

TABLE 1

| W_{SEL} [ft] | E_{door} [ft] |
|---|---|
| 0.762 | 0.732 |
| 1.000 | 0.513 |
| 2.000 | 0.325 |
| 3.000 | 0.260 |
| 4.000 | 0.223 |
| 5.000 | 0.199 |

For: Q=1 CFS, W=5 in, C_{d}=0.68, and g=32.2 ft/sec\hat{ }2, with a 10.75-foot float rod

TABLE 2

| W_{SEL} [ft] | E_{door} [ft] |
|---|---|
| 0.762 | 0.732 |
| 1.000 | 0.513 |
| 2.000 | 0.325 |
| 3.000 | 0.260 |
| 4.000 | 0.223 |
| 5.000 | 0.199 |
| 6.000 | 0.181 |
| 7.000 | 0.167 |
| 8.000 | 0.156 |
| 9.000 | 0.147 |
| 10.000 | 0.140 |

For: Q=5 CFS, W=10 in, C_{d}=0.68, and g=32.2 ft/sec\hat{ }2, with a 5.75-foot float rod

TABLE 3

| W_{SEL} [ft] | E_{door} [ft] |
|---|---|
| 1.400 | 1.365 |
| 2.000 | 0.884 |
| 3.000 | 0.675 |
| 4.000 | 0.571 |
| 5.000 | 0.505 |

For: Q=5 CFS, W=10 in, C_{d}=0.68, and g=32.2 ft/sec\hat{ }2, with a 10.75-foot float rod

TABLE 4

| W_{SEL} [ft] | E_{door} [ft] |
|---|---|
| 1.400 | 1.365 |
| 2.000 | 0.884 |
| 3.000 | 0.675 |
| 4.000 | 0.571 |
| 5.000 | 0.505 |
| 6.000 | 0.458 |
| 7.000 | 0.422 |
| 8.000 | 0.394 |
| 9.000 | 0.370 |
| 10.000 | 0.351 |

For: Q=10 CFS, W=15 in, C_{d}=0.68, and g=32.2 ft/sec\hat{ }2, with a 5.75-foot float rod

TABLE 5

| W_{SEL} [ft] | E_{door} [ft] |
|---|---|
| 1.690 | 1.673 |
| 2.000 | 1.266 |
| 3.000 | 0.922 |
| 4.000 | 0.772 |
| 5.000 | 0.680 |

For: Q=10 CFS, W=15 in, C_{d}=0.68, and g=32.2 ft/sec\hat{ }2, with a 10.75-foot float rod

TABLE 6

| W_{SEL} [ft] | E_{door} [ft] |
|---|---|
| 1.690 | 1.673 |
| 2.000 | 1.266 |
| 3.000 | 0.922 |
| 4.000 | 0.772 |
| 5.000 | 0.680 |
| 6.000 | 0.615 |
| 7.000 | 0.566 |
| 8.000 | 0.527 |
| 9.000 | 0.496 |
| 10.000 | 0.469 |

For: Q=20 CFS, W=20 in, C_{d}=0.68, and g=32.2 ft/sec\hat{ }2, with a 5.75-foot float rod

TABLE 7

| W_{SEL} [ft] | E_{door} [ft] |
|---|---|
| 2.227 | 2.145 |
| 3.000 | 1.468 |
| 4.000 | 1.194 |
| 5.000 | 1.040 |

For: Q=20 CFS, W=20 in, C_{d}=0.68, and g=32.2 ft/sec\hat{ }2, with a 10.75-foot float rod

TABLE 8

| W_{SEL} [ft] | E_{door} [ft] |
|---|---|
| 2.227 | 2.145 |
| 3.000 | 1.468 |
| 4.000 | 1.194 |
| 5.000 | 1.040 |
| 6.000 | 0.936 |
| 7.000 | 0.858 |
| 8.000 | 0.798 |
| 9.000 | 0.749 |
| 10.000 | 0.708 |

In a particular embodiment, we have used:

$$0.1 \leq Q \leq 100 [ CFS ]$$

$$0.5 \leq W \leq 50 [ in ]$$

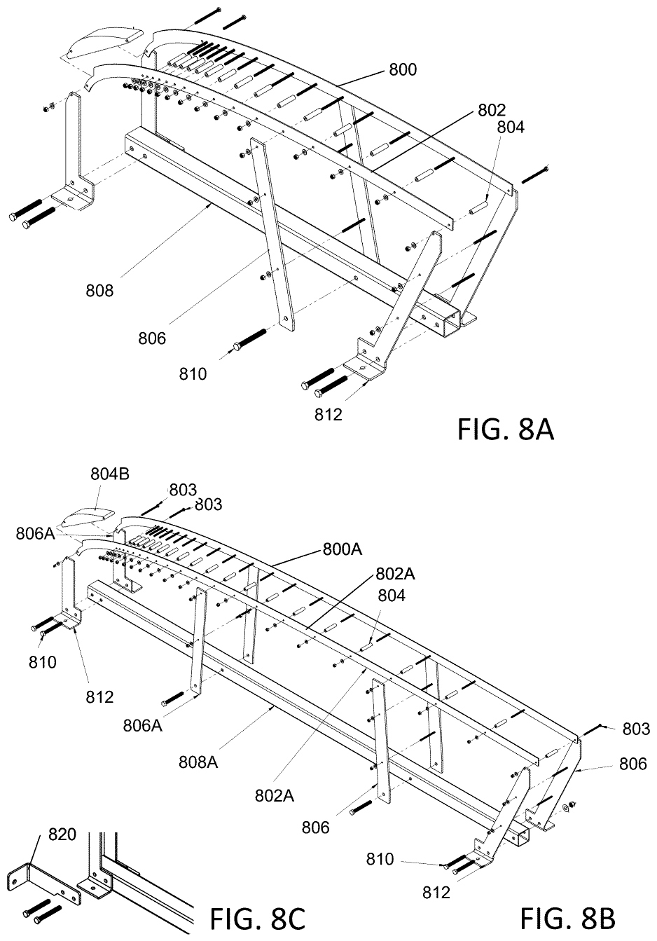

Examples of curved frames 124 built according to these equations are shown in FIGS. 8A and 8B, with FIG. 8A illustrating a curved frame for use with a 5.75 foot float rod, and FIG. 8B illustrating a curved frame for use with a 10.75-foot float rod. Each frame is assembled by assembling two appropriately-curved side rails 800, 802, 800A, 802A using bolts 803 passing through a side rail 800, 800A, spacers 804, and the second side rail 802, 802A. A curved solid spacer may be used at an end of the curve proximal to stationary frame 124 to provide curve accuracy for deep water movements. The side rails are bolted with struts 806, 806A to a base rod 808, 808A using more bolts 810 and flanges 812 are provided for bolting the curved frame to concrete structure of a ditch or in base of a detention basin. In embodiments, a bracket 820 (FIG. 8C) couples the curved frame 124 to stationary flame 204.

The horizontally adjustable opening defined by the frame 112 and the horizontal gate 110 and the vertically adjustable opening defined by vertical gate 116 and the frame 112 align sufficiently that water may pass through the horizontally adjustable opening and the vertically adjustable opening in sequence.

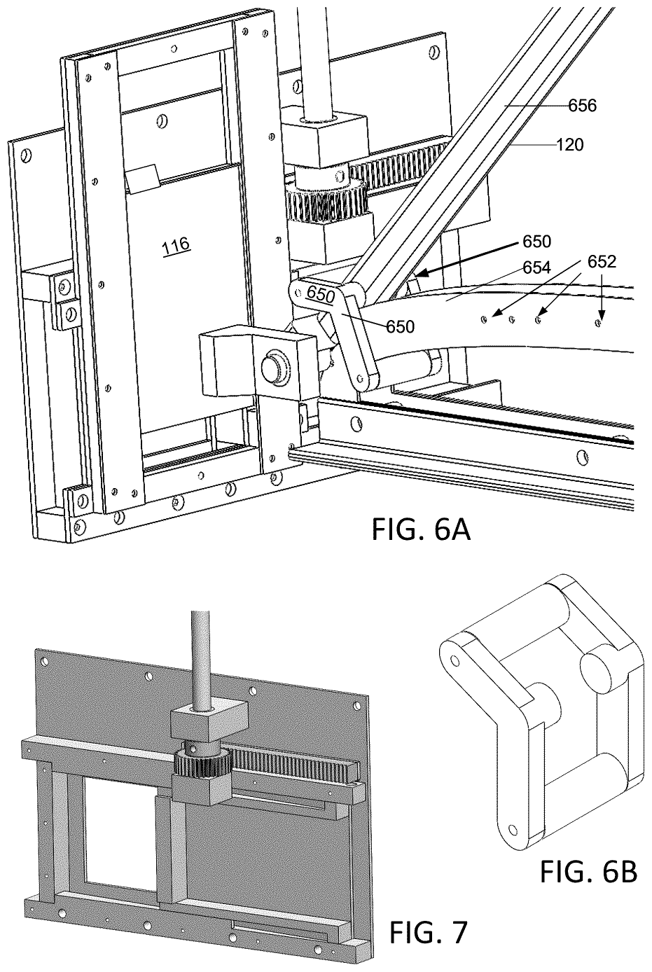

FIG. 6B illustrates a coupling slider 650. Coupling slider 650 is shown assembled to other components of the float-controlled gate assembly in FIG. 6A. The coupling slider helps retain the float control lever 120 in the slot 122 of the curved frame 124 and serves as a fulcrum to allow a rising float to force the vertical gate 116 down as the float rises. In this embodiment, the slot is formed between two curved plates 654 held apart by, and having a discontinuous bottom formed by, multiple spacers 652. In an embodiment, coupling slider 650 slides in an indented slot 656 along float control lever 120. Slider 650 may have one or more springs and stops that help it return to proper position when water levels are low.

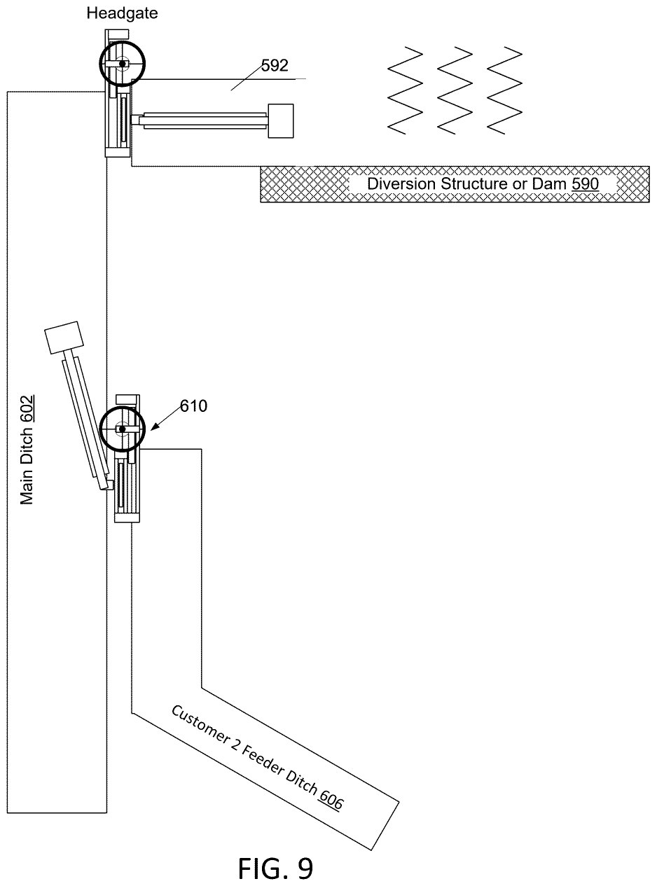

The gate as herein described may be used in an irrigation system or aqueduct system as illustrated in FIG. 9. A diversion structure or reservoir dam 590 impounds water of variable head that flows into a headgate structure 592. The depth of this water varies with factors such as how full the reservoir is, or, in the case of diversion structures, with stream flow. A headgate, comprising the steady-flow gate as herein described, receives this impounded water and admits a steady flow of water into a main ditch 602 that carries water to additional gates that may regulate water flow into one or more branch ditches. Where customer branch ditch 606 is parallel to, or at an angle other than a right angle to main ditch 602, the coupling illustrated in FIGS. 4 and 5 is used to couple vertical gate 116A to the float control lever 120A, as shown. In this irrigation embodiment, the horizontal gate may be used to enable or disable water to any particular branch ditch as well as adjusting a maximum flow into that branch ditch. Further, if the pinon is driven by a remotely-controlled electric motor, remote control of the horizontal gates may avoid the need for a ditch rider to operate the horizontal gates.

In an alternative embodiment, the gate assembly is located at an outlet of a detention basin; in a first embodiment the float and float control lever are located at the downstream end of the detention basin with the float in the detention basin. As the detention basin fills with water, the float matches the water surface elevation. As the water surface elevation, and thus the float, rise, the vertical gate is lowered so that the increased head is offset by a decreased area thus delivering a constant flow despite variations in head

In embodiments, the horizontal and vertical gates are steel, and in a particular embodiment stainless steel, but may also be manufactured primarily out of aluminum. As the gates are exposed to water under pressure, there are advantages to using strong, but corrosion resistant, materials. In embodiments, brass or bronze bushings are provided to smooth operation of both the horizontal and vertical gates.

In embodiments, the steel, stainless steel, or aluminum metal plate of each of the horizontal and vertical gates have on their downstream side a single or in a particular embodiment a double polymer seal attached to them and covering all areas that may rub on the frame. In embodiments, this polymer seal is formed of a low-friction polymer such as high-density polyethylene (HDPE) or a fluorocarbon polymer so that the seal not only seals the gate to reduce leakage, but provides lubrication to prevent binding of the gates during operation. In a particular embodiment the seals are formed of HDPE faced with 6061 T1 Aluminum. In an alternative embodiment, seals are formed of 6061 T1 aluminum sheet.

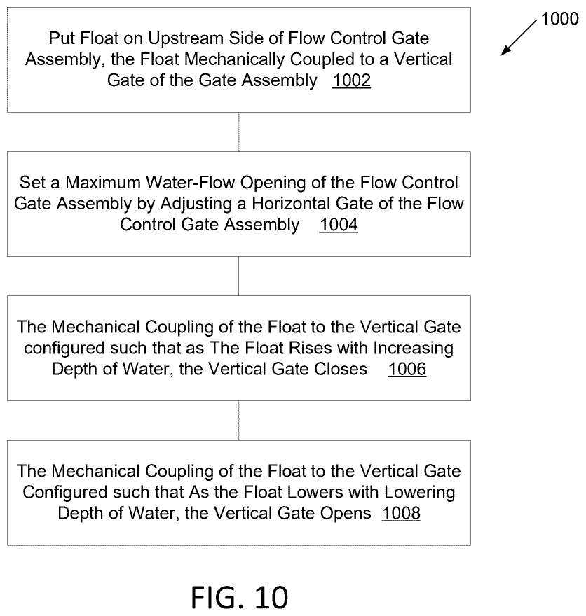

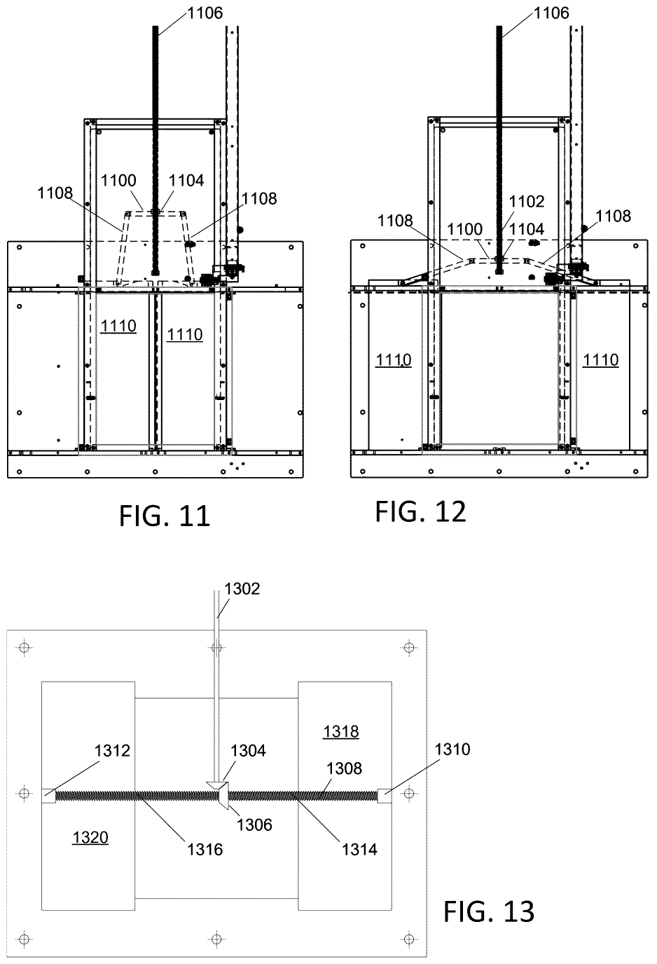

In a method 1000 (FIG. 10) of controlling water flow through a gate assembly, a float is positioned 1002 on an upstream side of flow control gate assembly, the float being mechanically coupled to a vertical gate of the gate assembly. The mechanical coupling of the float to the vertical gate is configured such that as the float rises with increasing depth of water, the vertical gate closes 1006 and such that as the float lowers with lowering depth of water, the vertical gate opens 1008. A maximum water-flow opening of the flow control gate assembly is adjusted 1004 by adjusting a horizontal gate of the flow control gate assembly. In embodiments, the float is coupled to the vertical gate through a control rod, the control rod riding on a curved frame, a curve of the frame determined to keep water flow constant as water depth changes.
1. An alternative horizontal gate for use in an embodiment is illustrated in FIGS. 11 and 12. In these embodiments, the horizontal gate has two separate leaves unlike the single-leaf horizontal gate illustrated in FIGS. 1A and 7. In these embodiments the vertical, float-controlled, gate is similar to those shown in the above described embodiments, so is omitted from FIGS. 11 and 12 for clarity. In these embodiments, a horizontal link bar 1100 has a nut 1104 engaged with a vertical screw 1102 portion of vertical adjustment shaft 1106, vertical adjustment shaft 1106 is coupled to an adjustment handwheel (not shown). When the horizontal gate is closed, FIG. 11, horizontal link bar 1100 is in a high position so that gate link bars 1108 pull the horizontal gate leaves 1110 together. When the horizontal gate is open, FIG. 12, horizontal link bar 1100 is in a low position so that gate link bars 1108 push the horizontal gate leaves 1110 apart; as the vertical adjustment shaft is rotated the threaded vertical screw portion 1102 drives nut 1104 and horizontal link bar 1100 upwards toward the high position causing gate link bars 1108 to draw the horizontal gate leaves 1110 together. The horizontal gate of the flow control gate assembly of FIGS. 11 and 12 has two leaves configured to slide horizontally together to close the horizontally adjustable opening and to slide horizontally apart to open the horizontally adjustable opening.

Another embodiment having a horizontal gate with two leaves configured to slide horizontally together to close the horizontally adjustable opening and to slide horizontally apart to open the horizontally adjustable opening is illustrated in FIG. 13. A vertical adjustment shaft 1302 is coupled to rotate a vertical bevel gear 1304. Vertical bevel gear 1304 is engaged with a horizontal bevel gear 1306 which is coupled to horizontal screw 1308. Horizontal screw 1308 has a right-hand thread on one end 1314 and a left-hand thread on another end 1316. The horizontal screw 1308 engages with a nut 1310 on a first horizontal gate leaf 1318 and a nut 1312 on a second horizontal gate leaf 1320. FIG. 13 illustrates the gate leaves positioned maximally apart. Rotation of vertical adjustment shaft in one direction causes the horizontal screw to rotate to draw the gate leaves together to close the horizontally adjustable opening and rotation of the vertical adjustment shaft in a second direction causes the horizontal screw to rotate to force the gate leaves apart to open the horizontally adjustable opening.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A flow control gate assembly comprising:
a horizontally adjustable gate in a frame, the horizontally adjustable gate actuated by an actuator, the horizontally gate in the frame defining a horizontally adjustable opening;
a vertically adjustable gate coupled by a flexible joint to a first end of a control lever, a second end of the control lever coupled to a float, the vertically adjustable gate defining a vertically adjustable opening;
the control lever being disposed in a slot of a frame; and
the control lever and frame being configured such that if the float is lowered to the frame the control lever raises the vertically adjustable gate;
wherein the horizontally adjustable opening and the vertically adjustable opening align sufficiently that water may pass through the horizontally adjustable opening and the vertically adjustable opening, and
wherein the horizontally adjustable gate is disposed close to the vertically adjustable gate.

2. The flow control gate assembly of claim 1 wherein the actuator comprises a rack and pinon gear.

3. The flow control gate assembly of claim 2 wherein the pinion is coupled to be operated by a handwheel.

4. The flow control gate assembly of claim 1 wherein the frame is curved, with a narrower radius of curve at a first end of the frame nearest the vertical gate and a wider radius of curve at a second end of the frame nearest the float at low water.

5. The flow control gate assembly of claim 1 where the flexible joint comprises a bracket attached to the vertical gate and a vertical pivot pin disposed through a hole in the bracket, the vertical pivot pin coupled to the control lever.

6. The flow control gate assembly of claim 5 where the vertical pivot pin is coupled to the control lever through a horizontal pivot pin attached to the control lever.

7. The flow control gate assembly of claim 1 wherein the pinion is coupled to an electric motor drive.

8. The flow control gate assembly of claim 1 where the curved frame is configured to set the size of the opening defined by the vertical gate of the flow control gate assembly approximately according to the equation:
$${E}_{door} = {[ {( - \frac{Q}{\frac{2}{3} {C}_{d} W \sqrt{2 g}} + {W}_{sel}^{\frac{3}{2}} )}^{2} ]}^{\frac{1}{3}} + {W}_{SEL}$$
$$and$$
$$H = {W}_{SEL} - \frac{{E}_{door}}{2}$$
Where:
E_{door}=Gate opening height [ft] and proportional to the size of the opening defined by the vertical gate,
H=Head [ft]
Q=Flow [CFS]
C_{d}=Coefficient of discharge [0.68]
W=Gate opening width [ft]
g=Gravity [32.2 ft/sec\hat{ }2]
W_{SEL}=Water surface elevation [ft].

9. An irrigation system comprising at least one main ditch fed from a diversion structure through the flow control gate assembly of claim 1.

10. An irrigation system comprising the irrigation system of claim 9 wherein the float is disposed upstream of the flow control gate assembly.

11. An irrigation system comprising at least one main ditch and at least one branch ditch coupled to the at least one main ditch through the flow control assembly of claim 1 such that water can flow from the at least one main ditch through the flow control assembly into the branch ditch.

12. The irrigation system of claim 10 wherein the pinion of the flow control assembly is coupled to a remotely controlled electric motor drive.

13. A detention basin comprising at least one flow control assembly of claim 1 disposed to discharge water out of the detention basin, where the float of the flow control assembly is disposed within the detention basin.

14. A method of controlling flow of water from an upstream side of a flow control gate assembly through the flow control gate assembly comprising:
adjusting a horizontal gate of the flow control gate assembly, the horizontal gate assembly disposed in series with a vertical gate of the flow control gate assembly; and
disposing a float upstream of the flow control gate assembly, the float mechanically coupled to partially close the vertical gate of the flow control gate assembly when the float is exposed to high water levels on the upstream side of the flow control gate assembly and partially or fully open the vertical gate of the flow control gate assembly when water levels the float is exposed to on the upstream side of the flow control gate assembly are reduced.

15. The method of claim 14 wherein the float is mechanically coupled by a float rod and a flexible joint to the vertical gate of the flow control gate assembly.

16. The method of claim 15 wherein the float rod contacts a curved frame, interaction of the float rod with the curved frame determining a size of an opening defined by the vertical gate of the flow control gate assembly.

17. The method of claim 16 where the curved frame is configured to set the size of the opening defined by the vertical gate of the flow control gate assembly approximately according to the equation:
$${E}_{door} = {[ {( - \frac{Q}{\frac{2}{3} {C}_{d} W \sqrt{2 g}} + {W}_{sel}^{\frac{3}{2}} )}^{2} ]}^{\frac{1}{3}} + {W}_{SEL}$$
$$and$$
$$H = {W}_{SEL} - \frac{{E}_{door}}{2}$$
Where:
E_{door}=Gate opening height [ft] and proportional to the size of the opening defined by the vertical gate,
H=Head [ft]
Q=Flow [CFS]
C_{d}=Coefficient of discharge [0.68]
W=Gate opening width [ft]
g=Gravity [32.2 ft/sec\hat{ }2]
W_{SEL}=Water surface elevation [ft].

18. The flow control gate assembly of claim 1 wherein the horizontal gate comprises two leaves configured to slide horizontally together to close the horizontally adjustable opening and to slide horizontally apart to open the horizontally adjustable opening.
